(19) United States
(12) Patent Application Publication
(10) Pub. No.: US 2002/0049612 A1
(43) Pub. Date: Apr. 25, 2002

(54) Method and system for clinical knowledge management

(76) Inventors: Scott H. Jaeger, Haddonfield, NJ (US); Harry J. Chororos, Roseland, NJ (US)

Correspondence Address: KENYON & KENYON, One Broadway, New York, NY, 10004, US

(21) Appl. No.: 09/815,646

(22) Filed: Mar. 23, 2001

Related U.S. Application Data
(60) Provisional application No. 60/191,524, filed on Mar. 23, 2000.
(60) Provisional application No. 60/191,967, filed on Mar. 24, 2000.

(51) Int. Cl. G06F 17/60; G06N 7/02; G06N 7/06; G06F 9/44

(52) U.S. Cl. 705/2; 705/3; 706/52

(57) ABSTRACT

The present invention provides a method and system for evaluation of a medical conclusion such as a diagnosis. The present invention may be applied either retrospectively to evaluate a prior medical conclusion or prospectively to evaluate one or more hypothetical medical conclusions. A core engine, which may be implemented as a back-end at a node coupled to an information network such as the Internet, converts raw medical data in the form of phrases into a normalized form, and then segments the normalized data into discrete temporal segments. The core engine also performs a clinical conclusion analysis and reporting process to evaluate one or more clinical conclusions with respect to the determined temporal segments.

### RELATED PROVISIONAL APPLICATION

The present application claims the benefit of U.S. Provisional Patent Application entitled Method And System For Clinical Knowledge Management, filed on Mar. 23, 2000, application No. 60/191,524 and U.S. Provisional Patent Application entitled Method And System For Clinical Knowledge Management, filed on Mar. 24, 2000, application No. 60/191,967.

### FIELD OF THE INVENTION

The present invention relates to computer networks and information systems. In particular, the present invention pertains to a computer based system and method for the analysis and evaluation of medical conclusions.

### BACKGROUND INFORMATION

Medicine is one of the most data intensive, but least automated industries. The present state of medical informatics is limited to demographics. Clinical data is expressed with rudimentary information available from ICD and CPT codes. Current technology relies upon representation of clinical information in text form using phrases. Expert systems technology has also been developed in order to provide automated computer support to the practice of medicine. However, these systems generally do not provide meaningful analysis of medical data based upon discrete temporal segments.

In particular, current approaches are unable to convey generalities or nuances of data that can easily be manipulated and analyzed via information processing devices such as computers. Each segment in a medical history of a patient relating to a claim necessarily involves one or more clinical conclusions, which inform a treatment plan, medical tests ordered, diagnoses and follow-up procedures. However, known expert systems for providing medical analysis do not allow the evaluation of medical clinical conclusions relating to particular segments of a medical history.

In order to provide meaningful representation and analysis of medical data, it is necessary to develop a codification system that emulates the methodology employed by doctors and other health care professionals.

### SUMMARY OF THE INVENTION

The present invention provides a method and system for evaluation of a medical conclusion such as a diagnosis. The present invention may be applied either retrospectively to evaluate a prior medical conclusion or prospectively to evaluate one or more current medical conclusions.

According to one embodiment, a medical analysis site is coupled to an information network such as the Internet. Clients including medical payors, medical providers and employers interact with the medical analysis site via the information network. The medical analysis site receives input data from clients either in the form of raw medical documents, which are further processed at the medical analysis site or via a data input interface from an operator.

The medical analysis site includes a front-end subsystem (e.g., a World Wide Web server) for providing a graphical user interface (“GUI”) for clients to interact with the site, a core engine, which performs at least one process for analyzing and evaluating medical conclusions and a patient record database, which stores normalized medical data relating to medical histories of patients. The medical analysis site stores a predefined set of medical essential elements to represent and normalize events in a medical history including symptom reports, treatments, clinical conclusions, laboratory tests, chronological factors, demographic factors, etc.

According to one embodiment of the present invention, the core engine includes a processor and a relational database, which further includes a medical essential element database, a medical phrase database, a chronological rules database and a medical knowledge rules database. The medical phrase database maps at least one medical phrase to an essential element. The medical knowledge rules database maps each essential element to at least one clinical conclusion using a membership confidence function and a criterion impact parameter. The membership confidence function relates a degree of confidence that a particular essential element points to a particular clinical conclusion as a function of a medical assessment. The criterion impact parameter expresses an importance weight to be assigned a particular essential element with respect to a particular clinical conclusion. The chronological rules database stores information, which is used to segment medical data into discrete segments for further processing.

The medical analysis site also includes a patient record database, which stores normalized patient claim medical data, which is processed by the core engine.

The core engine performs an encoding process, a data structuring/sequencing process and a clinical conclusion/reporting process. During the encoding process, the core engine maps a set of medical data relating to one or more medical claims to a set of essential elements. In particular, according to one embodiment, the medical analysis site receives medical data relating to patient claims. The medical data may be submitted in the form of raw medical documents in which case OCR (“Optical Character Recognition”) technology is employed to render the data in a computer readable form. In an alternative embodiment, an operator may directly submit medical data to the medical analysis site via input forms generated by the front-end subsystem. The core engine parses received medical data into discrete phrases, which are compared with data stored in the medical essential element database. If a matching phrase is found, a corresponding essential element record is instantiated in the patient record database. The core engine then segments medical elements stored in the patient record database relating to a particular medical claim into discrete temporal segments using chronological rules stored in the chronological rules database.

The core engine also performs a clinical conclusion analysis and reporting process to evaluate one or more clinical conclusions with respect to the temporal segments determined in the sequencing process. In particular, data gleaned from a patient's medical experience is compared with a known “best case” scenario for each specific clinical conclusion. The results of the clinical conclusion and analysis process are then reported in graphical form for review.

### BRIEF DESCRIPTION OF THE DRAWINGS

FIG. 1a depicts a relationship between medical data and a number of essential medical elements according to one embodiment of the present invention.

FIG. 1b depicts an exemplary hierarchical structure for representing a relationship between essential elements according to one embodiment of the present invention.

FIG. 1c depicts a relationship between a number of utility groups and classes according to one embodiment of the present invention.

FIG. 1d depicts a schematic of a process for evaluating medical clinical conclusions according to one embodiment of the present invention.

FIG. 2 depicts a network architecture illustrating the relationship between a medical analysis site and various clients.

FIG. 3a depicts the architecture of a core engine relational database according to one embodiment of the present invention.

FIG. 4a depicts a data structure for storing an essential element record according to one embodiment of the present invention.

FIG. 4b depicts a data structure for storing a phrase record in a phrase database according to one embodiment of the present invention.

FIG. 4c depicts a data structure for storing a chronological rule record according to one embodiment of the present invention.

FIG. 4d depicts a data structure for storing a medical rule record according to one embodiment of the present invention.

FIG. 5a depicts the hierarchical structure of a patient record database according to one embodiment of the present invention.

FIG. 5b depicts a data structure for representing an exemplary patient record according to one embodiment of the present invention

FIG. 5c depicts a data structure for representing a claim record according to one embodiment of the present invention.

FIG. 5d depicts a data structure for representing a temporal segment according to one embodiment of the present invention.

FIG. 5e depicts a data structure for representing an event according to one embodiment of the present invention.

FIG. 6a is a flowchart that depicts a series of steps for performing analysis of medical data according to one embodiment of the present invention

FIG. 6b is a flowchart of steps depicting document parsing/phrase matching/encoding.

FIG. 6c is a flowchart of steps depicting a sequencing process according to one embodiment of the present invention.

FIG. 7 is a flowchart of steps for generating a clinical conclusion report according to one embodiment of the present invention

FIG. 8a shows a sample report according to one embodiment of the present invention.

FIG. 8b shows an exemplary report including various sample data points according to one embodiment of the present invention.

FIG. 9a illustrates an exemplary fuzzy logic membership function relating a measurement value for an essential element with a confidence parameter according to one embodiment of the present invention.

FIG. 9b illustrates the evaluation of a clinical conclusion with respect to a number of essential elements according to one embodiment of the present invention.

### DETAILED DESCRIPTION

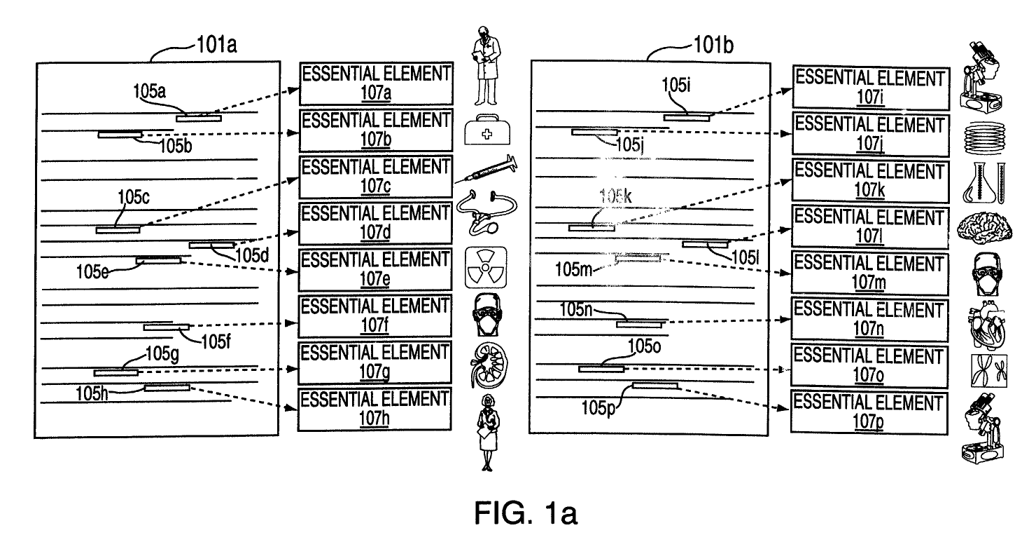

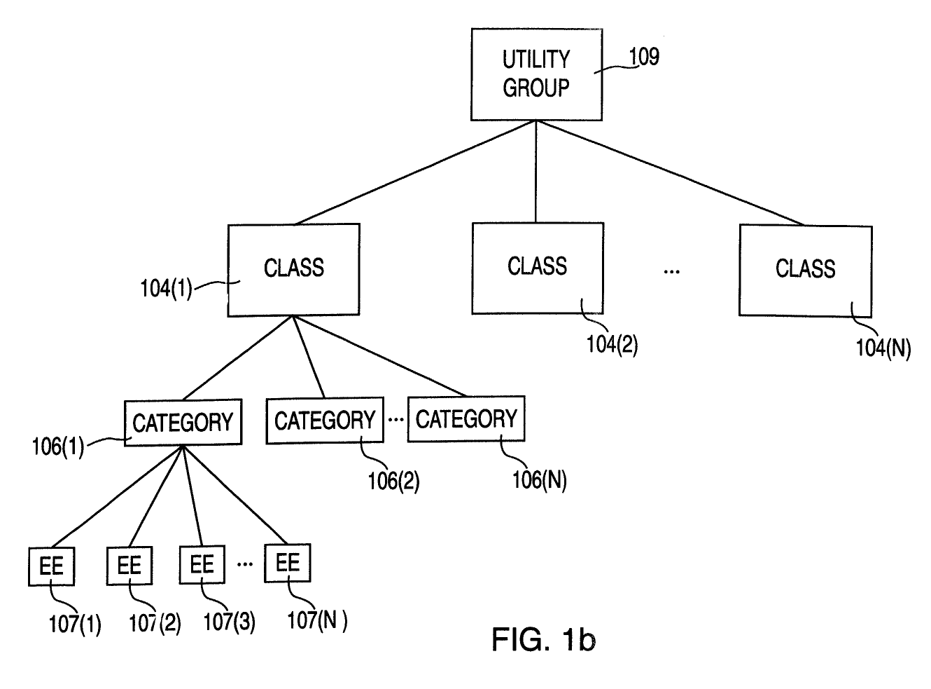

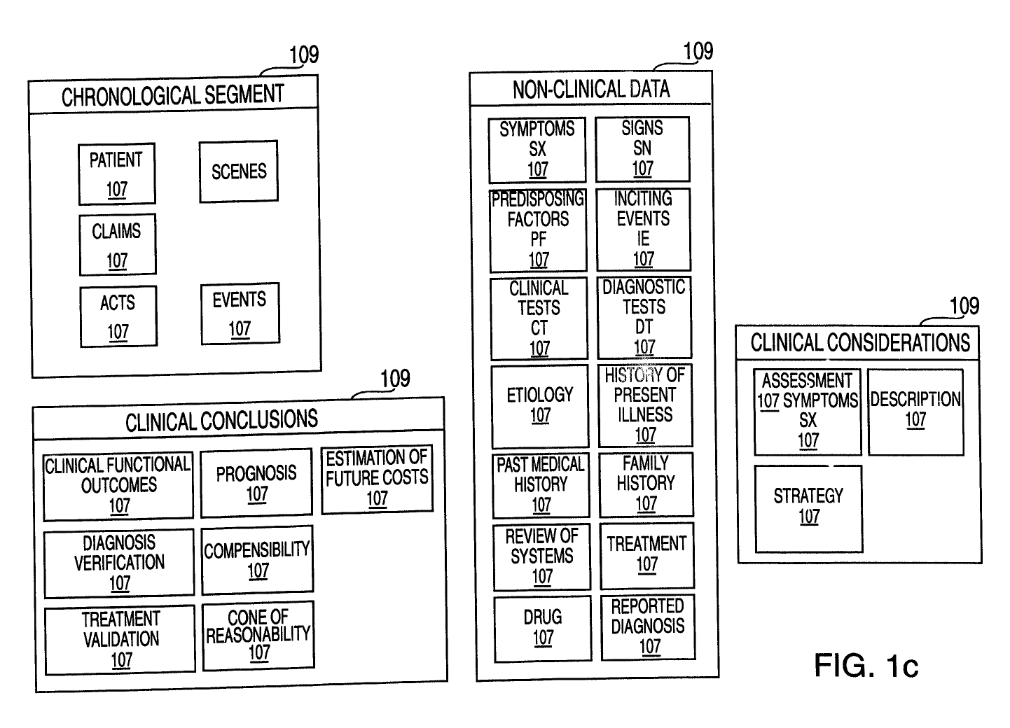

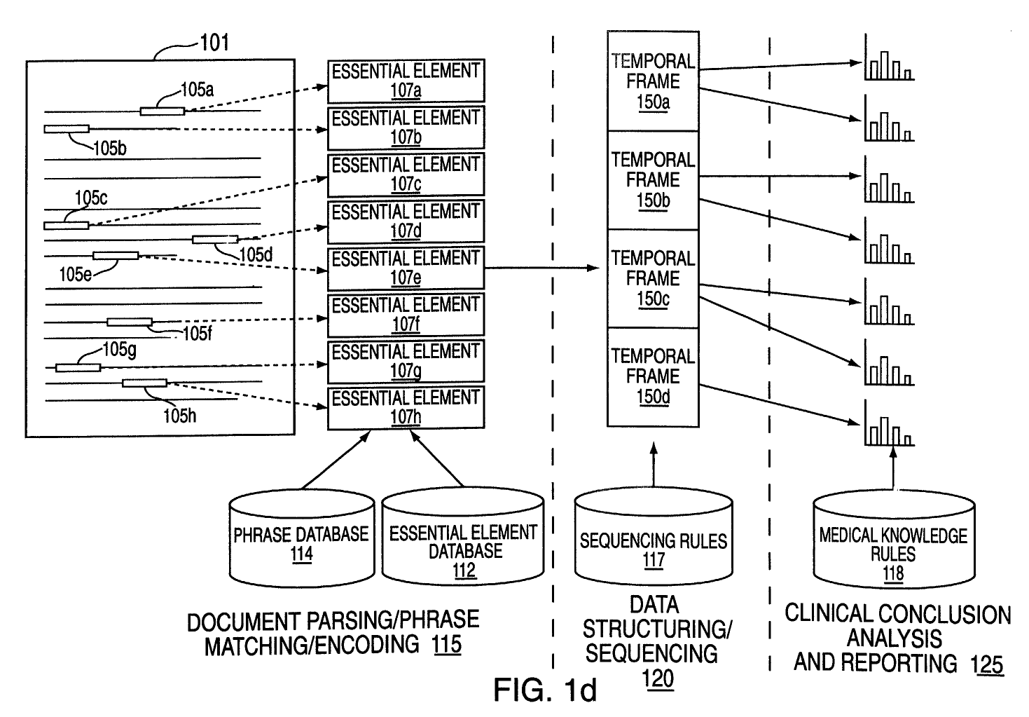

FIG. 1a depicts a relationship between medical data and a number of essential medical elements according to one embodiment of the present invention. Medical data typically includes a myriad of discrete data elements (herein referred to as “essential elements”) such as patient symptoms, test reports, clinical conclusions, etc., which hold significance in evaluating or performing a diagnosis. Typically, these discrete data elements are distributed in patient records as a function of test results, evaluations, examination, etc. FIG. 1a depicts exemplary medical records 101a and 101b, which each medical record includes a plurality of medical phrases 105a-105p. Medical phrases 105 may be gleaned from medical documents 101 via optical character recognition (“OCR”) technology or via manual text entry via an operator. Medical phrases may then be identified with particular essential elements in order to normalize the medical data. For example, different doctors may utilize slightly different terminology to refer to a common symptom. By identifying particular discrete data elements with essential elements, variations in phraseology or terminology may be eliminated and patient data normalized to a predefined set of medical elements.

FIG. 1b depicts an exemplary hierarchical structure for representing a relationship between essential elements according to one embodiment of the present invention. As shown in FIG. 1b, essential elements 107(1)-107(N) are included in category 106(1), categories 106(l)-106(N) are included in class 104(1) and classes 104(1)-104(N) are included in utility group 109. Note that FIG. 1b depicts a single utility group 109. Any arbitrary number of utility groups 109, each of which utilizes a unique relationship for the representation of essential elements may be defined. For example, FIG. 1c depicts a relationship between a number of utility groups 109 and classes according to one embodiment of the present invention. As shown in FIG. 1c, a non-clinical data utility group 109 includes, among other classes, symptoms class 107, predisposing factors class 107, treatment class 107, diagnostic tests class 107, etc. Thus, for example, symptoms class 107 might include a number of categories 106 and/or essential elements 107 that relate to various symptoms. Chronological segment utility group 109 includes various classes relating to temporal markers in a medical history. For example, chronological segments may include various events in a medical history that represent natural segmenting points such as operative procedures, office visits, etc.

FIG. 1d depicts a schematic of a process for evaluating medical clinical conclusions according to one embodiment of the present invention. As described in detail below, according to one embodiment, the present invention provides a system, which receives a plurality of medical phrases relating to a medical history of a patient. The system provides output of an overall level of confidence parameter relating to various clinical conclusions derived in the medical history. According to one embodiment of the present invention, a database of essential medical elements is maintained, which is utilized to normalize medical phrases either gleaned from medical records or provided via operator input. Medical essential elements may relate to clinical data such as etiology, predisposing factors, inciting events, etc., demographic information, diagnosis etc. For example a Patient may have an initial consultation with a doctor relating to a particular medical condition. During the initial consultation, various significant medical events may occur such as laboratory tests, administration of various treatments,

In a document parsing/phrase matching phase 115, medical data is received, parsed and normalized according to a pre-defined set of medical essential elements. According to one embodiment, as shown in FIG. 1b medical data is received in the form of raw medical records 101. Medical record 101 is parsed to locate relevant medical phrases 105 utilizing phrase database 114. The phrases are then resolved into essential medical elements 107 utilizing essential element database 112.

In a data structuring/sequencing phase 120, normalized medical data is segmented into temporal frames 150(a)-150(d) based upon sequencing rules 117. In a clinical conclusion analysis and reporting phase 125, the temporal frames 150-150(d) are analyzed with respect to one or more clinical conclusions and reports are generated. Note, that FIG. 1d depicts only 4 temporal frames (150a-150d) but the present invention is compatible with the generation of any number of temporal frames. The details of each of these processes are discussed in detail below.

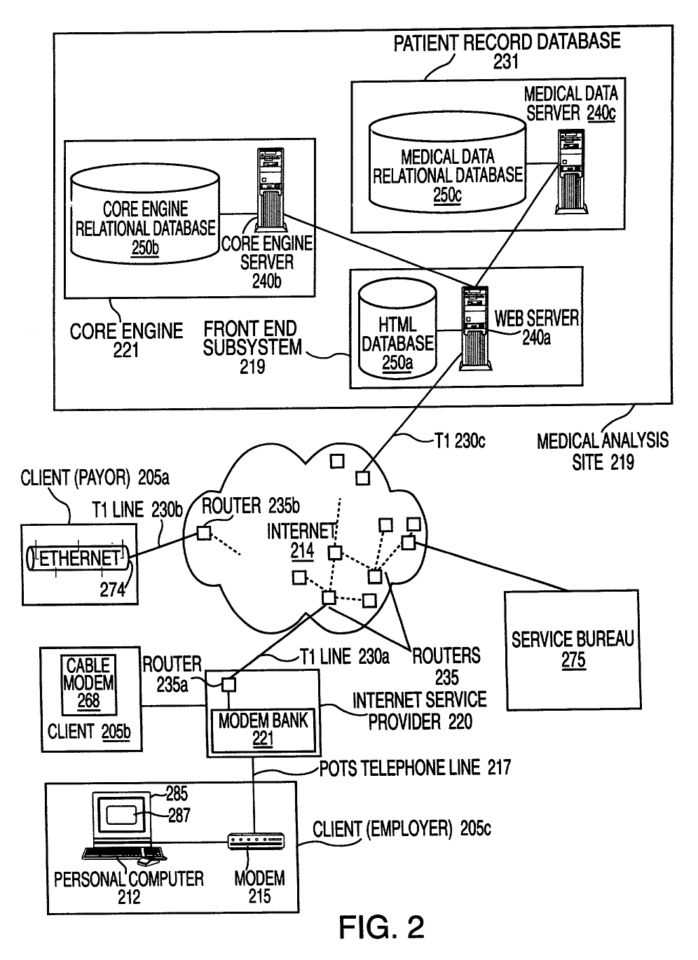

FIG. 2a depicts a network architecture illustrating a relationship between a medical analysis site and various clients. In particular, FIG. 2a illustrates a relationship between payor client 205a, provider client 205b, employer client 205c, medical analysis site 219 and service bureau 275.

Medical analysis site 219 is associated with one or more IP (“Internet Protocol”) addresses, which correspond to a unique destination address on Internet 214. Client 205c is typically associated with a dynamically assigned unique IP address, which is assigned upon dial-up by ISP 220. The unique IP addresses of client 205c and medical analysis site 219 permit transmission of data between client 205c and medical analysis site 219 via Internet 214. In particular, personal computer 212 packetizes data destined for medical analysis site 219 with a header, which includes the IP address of medical analysis site 219. This data is read and recognized by various routers 235 coupled to Internet 214,which route data packets containing the IP address of medical analysis site 219 to medical analysis site 219. Similarly, medical analysis site packetizes data destined for client 205c with the dynamically assigned IP address of client 205c, which is used to route data to client 205c.

As shown in FIG. 2, client 205c uses browser software 287 running as a separate process on personal computer 212 to transmit electronic signals representing information to medical analysis site 219 and to receive electronic signals from medical analysis site 219. Browser software 287 permits navigation between various file servers connected to Internet 214, including Web server 240 at medical analysis site 219. Browser software 287 also provides functionality for rendering of files distributed on the Internet (i.e., through plug-ins or Active X controls), which are displayed on display device 285.

Personal computer 212 communicates with Internet service provider (“ISP”) 220 through a dial-up connection using modem 215, through POTS line 217 to a central office (not shown) and the public switched telephone network (“PSTN”) (not shown). Typically, the transmission path from modem 215 through POTS line 117 to the central office is analog. At the central office, signals are sampled for digital transmission through the PSTN to ISP 220. Due to the analog nature of the transmission path from modem 215 through POTS line 217 to the central office, modem 215 performs modulation of digital signals generated by personal computer 212 onto an analog carrier signal for transmission to the central office. Modem 215 also performs demodulation of signals received over local lines (e.g., 217) from the central office, extracting digital byte codes from a modulated analog carrier.

ISP 220 is coupled to the PSTN through modem bank 221, which converts an analog modulated signal to a digital signal. Digital IP packets are then transmitted via Internet 114 and various routers (not shown) to Web server 240. IP packets are also transmitted in the reverse direction from Web server 240 to personal computer 212 via a path through Internet 214 and other routers, through ISP 220, modem bank 221, PSTN, central office and modem 215.

Network protocols and the network protocol stack in relationship to the OSI (“Open System Interconnection”) for communication over Internet 214 and Web are well known. According to one embodiment of the present invention, browser software 287 uses HTTP to retrieve a particular hypertext Web page assigned a particular URL on the Web. Each HTTP interaction consists of one ASCII (“American Standard Code for Information Interchange”) request followed by one RFC (“Request For Comments”) 822 MIME (“Multipurpose Internet Mail Extensions”) response. The HTTP connection is conducted over transmission control protocol (TCP) network layer. The TCP layer provides for a reliable stream-oriented connection between a server (e.g., 240) and personal computer 212 by resending data if necessary due to network overloads or malfunctions. Typically both personal computer 212 and Web server 240 run a TCP process that manages TCP streams and interfaces to an IP (Internetwork Protocol) layer. The TCP entity accepts user data streams from local processes, breaks them into segments and sends each piece as a separate IP datagram. On the other hand, when IP datagrams containing TCP data arrive at a machine, they are passed to the TCP process for reconstruction of the original byte streams.

The IP protocol at the network layer provides an addressing mode for sending packetized data from personal computer 212 to Web server 240 and vice versa. Point to point protocol (“PPP”) at the data link layer primarily provides a framing method for sending data to the physical layer. PPP also allows IP addresses to be negotiated at connection time. The PPP protocol encodes the IP/TCP/HTTP packets and transmits them to modem 215 and the physical layer. The physical layer is the actual physical medium through which communications occur, e.g., twisted pair, coaxial cable, optical fiber, etc.

Although according to the embodiment described herein, HTTP communication between personal computer 112 and Web server 140 is conducted over a TCP/IP connection, other communication protocols are possible and this example is not intended to limit the claims appended hereto. For example, a UDP (“User Datagram Protocol”) implementation is possible.

It is to be understood that in general clients 205 may connect to Internet 114 using any potential medium whether it be a dedicated connection such as a cable modem, T1 line, DSL (“Digital Subscriber Line”) or a dial-up POTS connection. For example, in addition to client 205c, FIG. 2a also shows clients 205a and 205b. Client 205b is coupled to Internet 214 via cable modem 268 and ISP 220. Client 205a, on the other hand, is a corporate client that is coupled to Internet 214 via T1 line 230b and router 235b. In this case, various node terminals (not shown) at client 205a share the bandwidth on T1 line 230b, wherein the bandwidth is distributed via Ethernet 274.

Service bureau 275 also communicates with medical analysis site 219 via Internet 214.

Medical analysis site 219 includes front-end subsystem 219, core engine 221 and patient record database 231. Front-end subsystem 219 provides a graphical user interface (“GUI”) for clients connecting to medical analysis site 219. In particular, front-end subsystem 219 includes web server 240a and HTML (“Hypertext Markup Language”) database 250a. Web server 240a serves HTML pages from HTML database 250a to clients 205 connecting with medical analysis site 219. Core engine 221 performs various backend processing functions at medical analysis site 219 related to the analysis of medical data as described in more detail below. Web server 240a is coupled to core engine server 240b at core engine 220, which is coupled to core engine relational database 250b. Patient record database 231 stores medical claim data relating to various patients in a normalized format as described in more detail below. Web server 240a is also coupled to medical data server 240c, which is coupled to medical data relational database 250.

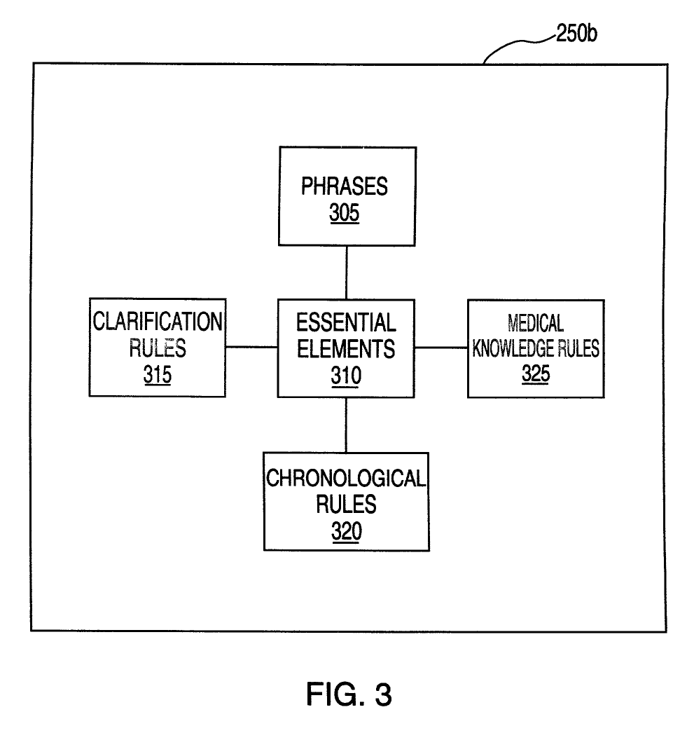

FIG. 3 depicts the architecture of a core engine relational database according to one embodiment of the present invention. Core engine relational database 250b establishes a relational structure between essential elements 310, phrases 305, chronological rules 320, clarification rules 315 and medical knowledge rules 325.

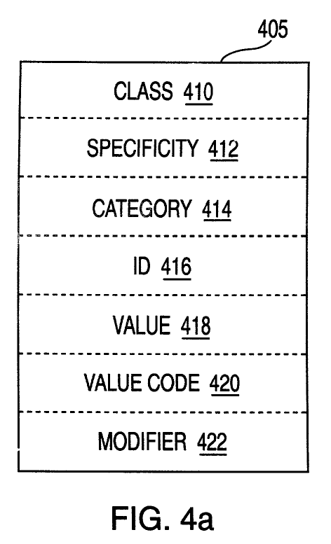

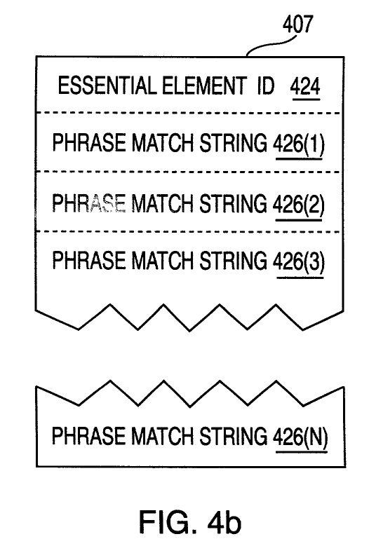

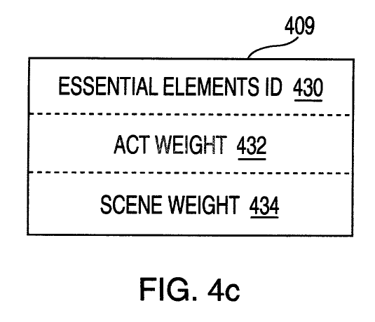

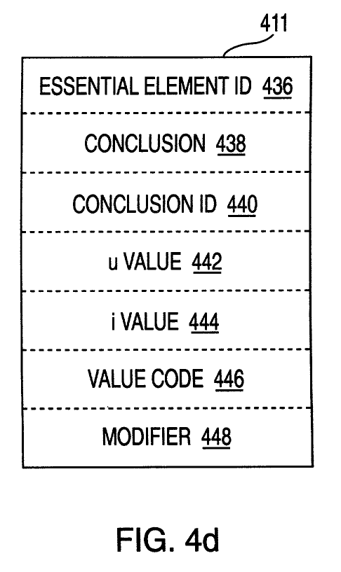

FIG. 4a depicts a data structure for storing an essential element record according to one embodiment of the present invention. Each essential element record 405 includes class field 410, specificity field 412, category field 414, ID field 416, value field 418, value code field 420 and modifier field 422. Class field 410 stores a two-byte class that refers to the class of an essential element 107. Specificity field 412 stores an integer value representing a degree of specificity associated with an essential element. For example, an essential element “Operative Procedure” might be assigned a specificity value of 0, while an essential element “Endoscopic Carpal Tunnel Release—Chow Technique” might be assigned a specificity value 9 because the latter essential element engenders a higher degree of specificity with respect to particular clinical conclusions than the former. ID field 416 stores a 32-bit ID field derived from conventional code sources such as ICD or CPT. Value field 418 stores a binary value that represents whether an essential element is quantified with a numeric value (i.e., value code field 420). For example, some essential elements refer to parameters that may be measured during an examination etc. such as body weight etc. In this case, value field 418 would store a binary ‘TRUE’ value indicating that the essential element is quantified. If value field 418 is ‘TRUE’, value code field 420 stores either a floating-point value representing a quantified essential element value. Modifier field 422 stores a text string relating to other information related to the essential element.

FIG. 4b depicts a data structure for storing a phrase record in a phrase database according to one embodiment of the present invention. Each phrase record 407 includes an essential element ID 424 field and at least one phrase match string 426(l)-426(N). Essential element ID field 424 stores a unique 32-bit value of an essential element (i.e., from ID field 416). Phrase match string fields 426(l)-426(N) each store an ASCII (“American Standard Code For Information Interchange”) string to be mapped to the essential element with ID stored in field 424.

FIG. 4c depicts a data structure for storing a chronological rule record according to one embodiment of the present invention. Each chronological rule record 409 includes act weight field 432 and scene weight field 414. Act weight field 432 stores a floating point value between 0-1 that represents the degree of confidence a particular event constitutes a change in temporal segment (e.g., an act). Scene weight field 434 stores a floating-point value between 0-1 that represents the degree of confidence that a particular event constitutes a change in a scene temporal segment.

FIG. 4d depicts a data structure for storing a medical rule record according to one embodiment of the present invention. Each medical rule record 411 includes essential element ID field 436, conclusion field 438, μ value field 442, ι value field 444, value code field 446 and modifier field 448. Essential element ID field 436 stores the ID of an essential element associated with a clinical conclusion. Conclusion field 438 stores a 32-bit integer value corresponding to a code for a particular clinical conclusion. μ value field 442 stores a floating-point value between 0-1 that represents a degree of confidence that the essential element referenced in field 436 leads to the impression of the conclusion referenced in field 438. ι value field 444 stores an integer value between 0-10 that represents an importance or impact that the essential element referenced in field 436 has on making the decision that the clinical conclusion referenced in conclusion ID field 440 is a member of a fuzzy set defined by that conclusion. Value code field 446 stores a 32-bit integer value that relates to a particular value to be associated with the essential element. According to one embodiment, this field may contain a pointer that references an analytical function that defines μ as a function of an independent variable. Modifier field stores a text string that further describes the essential element referenced in field 436.

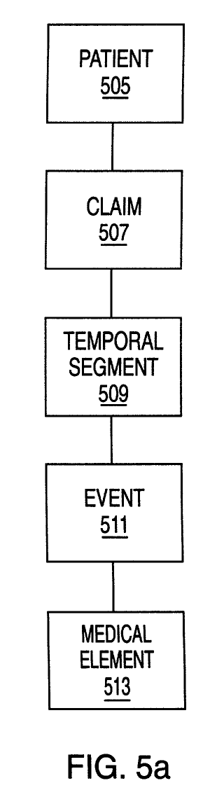

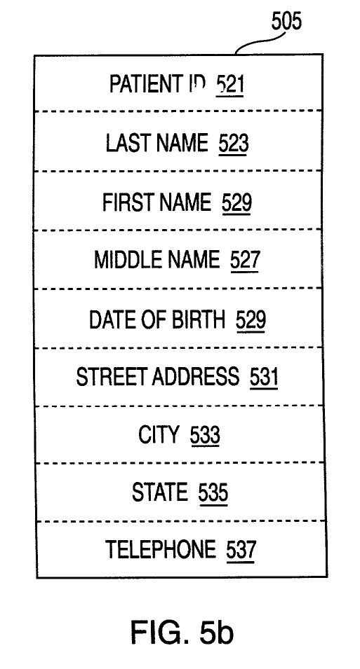

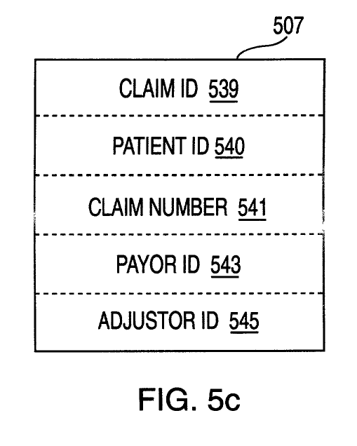

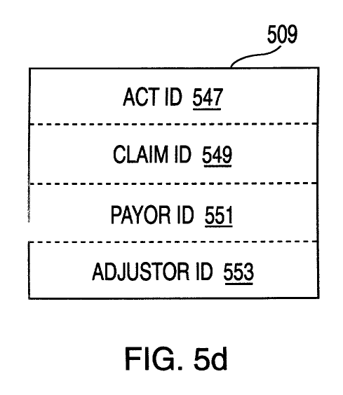

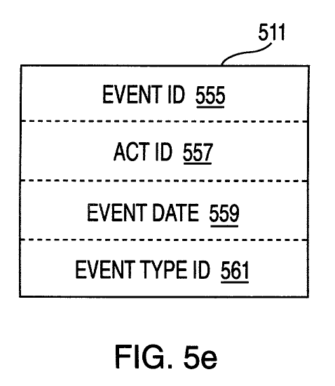

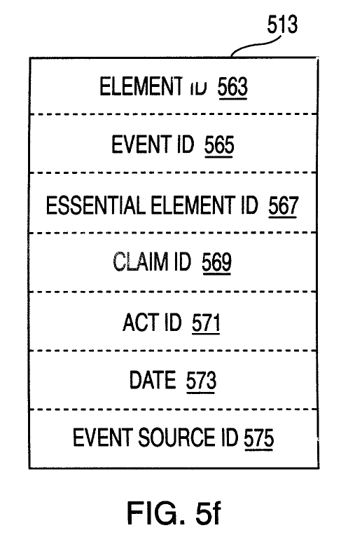

FIG. 5a depicts a hierarchical structure of a patient record database according to one embodiment of the present invention. At least one medical element 513 is associated with an event record 511. At least one event record 511 is associated with a temporal segment record 509. At least one temporal segment record 509 is associated with a claim record. At least one claim record 507 is associated with a patient record 505.

FIG. 5b depicts a data structure for representing an exemplary patient record according to one embodiment of the present invention. Each patient record 505 includes patient ID field 521, last name field 523, first name field 525, middle name field 572, date of birth field 529, street address field 531, city field 533, state field 535 and telephone field 537.

Patient ID field 521 stores a unique 32-bit integer value identifying a patient. Last name field 523, first name field 525, middle name field 527, date of birth field 529, street address field 531, city field 533, state field 535 and telephone field 537 each store an ASCII string representing a last name, first name, middle name, date of birth, street address, city, state and telephone number of a patient respectively.

FIG. 5c depicts a data structure for representing a claim record according to one embodiment of the present invention. Each claim record 507 includes claim ID field 539, patient ID field 540, claim number field 541, payor ID field 543 and adjuster ID field 545. Claim ID field 539 stores a unique 32-bit integer of a particular medical claim. Patient ID field 540 stores a patient ID (i.e., patient ID field 521) of the patient filing the claim. Claim number field 541 stores a unique 32-bit integer value representing a claim number. Payor ID field 543 and adjuster ID field 545 each respectively store 32-bit integer values relating to an ID of a payor and adjuster on the claim respectively.

FIG. 5d depicts a data structure for representing a temporal segment according to one embodiment of the present invention. According to one embodiment, each temporal segment is referred to as an act, which includes a set of events. For example, a temporal segment may be defined by a visit to a doctor's office, in which a variety of tests were performed, each comprising an element. As shown in FIG. 5d, each act record 509 includes act ID field 547, claim ID field 549, payor ID field 551 and adjuster ID field 553. Act ID field stores a unique 32-bit integer value defining an act. Claim ID stores the claim ID of a claim, which includes the act (i.e., claim ID field 539). Payor ID field 551 and adjuster ID field 553 each respectively store 32-bit integer values relating to the ID of a payor and adjuster on the claim respectively.

FIG. 5e depicts a data structure for representing an event according to one embodiment of the present invention. Each event record 511 includes event ID field 555, act ID field 557, event date field 559 and event type ID field 561. Event ID field stores a unique 32-bit integer corresponding to an event. Act ID field 557 stores an act ID number (i.e., field 547) corresponding to the event. Event date field 559 stores a date object variable representing a date upon which an event occurred. Event type ID field 561 stores a unique 32-bit integer value representing an event type.

FIG. 5f depicts a data structure for representing a medical element according to one embodiment of the present invention. An element record 513 is created for each medical phrase for which a corresponding essential element is found in essential element database 112. Each element record 513 includes element ID field 563, event ID field 565, essential element ID field 567, claim ID field 569, act ID field 571, date field 573 and event source ID field 575. Element ID field stores a unique 32-bit integer value generated for the element. Event ID field 565 stores an event ID of an event corresponding to the element (i.e., event ID field 555). Essential element ID field 567 stores an identifier of an essential element 107 corresponding to the element. Claim ID field 569 and act ID field 571 each respectively store an identifier of a corresponding claim and act. Date field 573 stores a date object variable representing a date upon which the element occurred. Event source ID field 575 stores an ASCII string describing a source of the essential element.

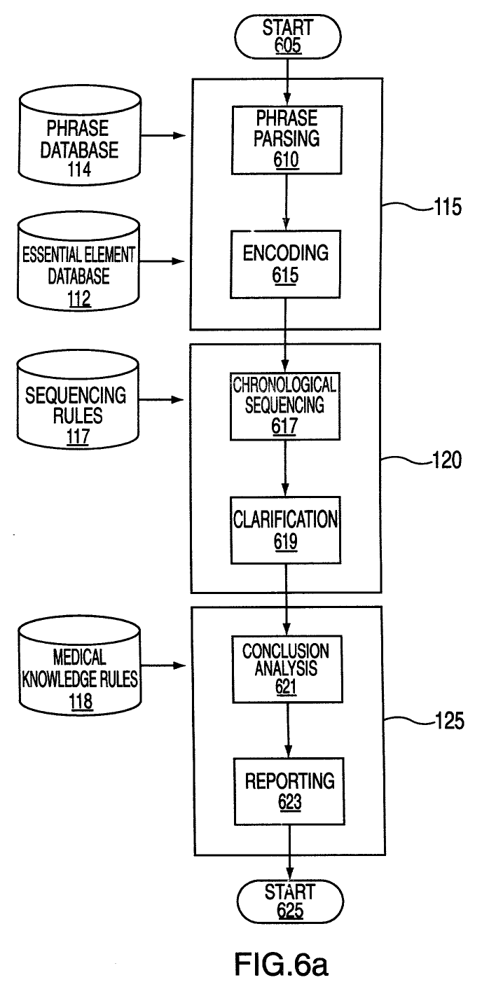

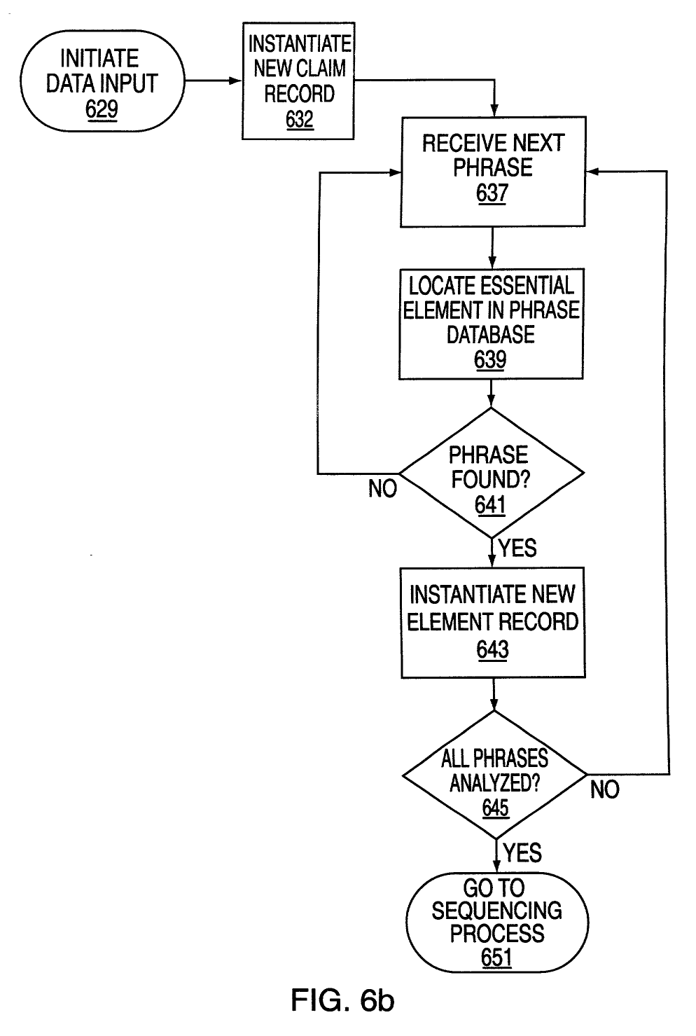

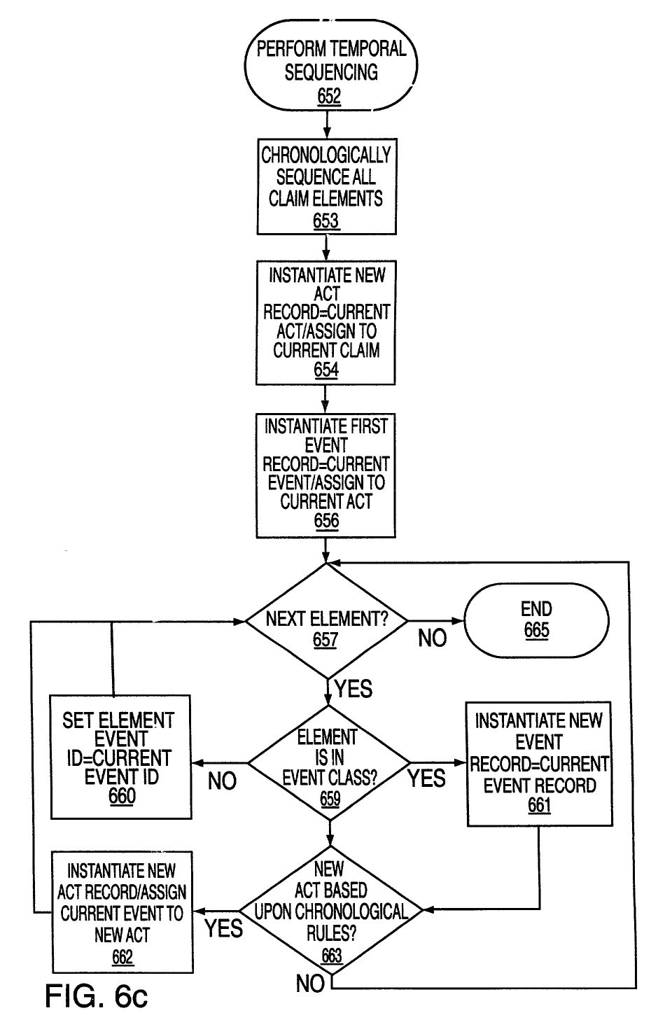

FIG. 6a is a flowchart that depicts a series of steps for performing analysis of medical data according to one embodiment of the present invention. According to one embodiment, the steps depicted in FIG. 6a are carried out by core engine server 240b at medical analysis site 219. The process is initiated in step 605. Steps 610 and 615 correspond to document parsing/phrase matching/encoding step 115 depicted in FIG. 1d. In step 610, medical data is parsed into phrases and a lookup operation is performed using phrase database 114 to determine matching phrases. In step 615, matching phrases are encoded into essential elements 107 by instantiating a medical element record 513 located for each matching phrase.

Steps 617 and 619 correspond to data structuring/sequencing process 120 in FIG. 1d. In step 617, chronological sequencing of all medical element records 513 instantiated in step 615 is performed. In particular, as described in detail below, medical element records 513 are ordered chronologically using date field 573 of element record 513. In addition, medical elements are segmented into temporal segments (e.g., acts) utilizing sequencing rules database 117 described below.

Steps 621 and 623 correspond to clinical conclusion and reporting process 20 125. In step 621, conclusion analysis is performed upon one or more temporal segments with respect to one or more clinical conclusions. In step 623, the outcome of clinical analysis step 621 is reported. The process ends in step 625.

### Document Parsing/Phrase Matching Encoding Process

FIG. 6b is a flowchart of steps depicting document parsing/phrase matching/encoding process 115 (i.e., steps 610 and 615 of FIG. 6a). The process depicted in FIG. 6b corresponds to the input of medical data relating to one medical claim and may be utilized either for automatic document parsing (e.g., using OCR) or for manual operator input of medical data. Practitioners skilled in the art will recognize that the process depicted in FIG. 6b may be elaborated or modified to receive data for multiple claims or multiple patients.

The process is initiated in step 629. In step 632a new claim record 507 is instantiated. In step 637, a next phrase is retrieved. According to one embodiment, the next phrase is retrieved via an OCR process from a medical document. In the alternative, if the input is provided manually, the next phrase is received from a human operator interacting with medical analysis site 219. In step 639, phrase database 114 is searched to locate a matching phrase. In step 641, it is determined whether the phrase is located in phrase database 114. If not (‘no’ branch of step 641), the next phrase is considered in step 637. If the phrase is located in phrase database (‘yes’ branch of step 641), in step 643, a new medical element record 513 is instantiated. In particular, a unique element ID is generated, which is used to populate element ID field 563. The essential element ID corresponding to the matched phrase is stored in essential element ID field 567 and the current claim ID is stored in claim ID field 569. The date pertaining to the element is stored in date field 573. In step 645, it is determined whether all phrases have been analyzed. If not (‘no’ branch of step 645, flow continues with step 637 and the next phrase is analyzed. If all phrases have been analyzed (‘yes’ branch of step 645), in step 651 a sequencing process is initiated.

### Data Structuring/Sequencing Process

FIG. 6c is a flowchart of steps depicting a sequencing process according to one embodiment of the present invention. The process is initiated in step 652. In step 653, all medical element records 513 are chronologically sorted based upon date field 573. In step 654, a new act record 509 is instantiated and set as the current act record. The ID of the current claim is then stored in claim ID field 549. In step 656, a new event record 511 is instantiated and set as the current event. The current act ID is stored in act ID field 557. In step 657, it is determined whether any of the sequenced elements have not been analyzed. If not (‘no’ branch of step 657), the process ends in step 665.

If there are remaining elements (‘yes’ branch of step 657), in step 659 it is determined whether the next element is an event class element (i.e. is included in the event class). If so (‘yes’ branch of step 659), a new event record is instantiated in step 661 and set as the current event. In step 663, it is determined whether a new act should be established based upon chronological rules. In particular, according to one embodiment of the present invention, a lookup process is performed using the chronological rules database to locate the event corresponding to the current event and the corresponding rule is applied to determine whether a new act should be established. According to one embodiment, for example, the μ value for the current event is retrieved from the chronological rules database. If the μ value exceeds a certain value such as 0.7, a new act is established unless a new act occurred less than fourteen days prior. If the chronological rules dictate that a new act should be established (‘yes’ branch of step 663), in step 662 a new act record is instantiated and the current event is assigned to the new act record. Flow continues with step 657. If a new act is not necessitated (‘no’ branch of step 663), flow continues with step 657. If the current element is not an event (‘no’ branch of step 659), in step 660, the element event ID is set to be equal to the current event ID. Flow continues with step 657.

### Clinical Conclusion Analysis And Reporting

After data structuring and sequencing, core engine 221 performs a clinical conclusion analysis and reporting process. Normalized patient data relating to a particular claim stored in patient record database 231 is analyzed and compared with a best-case scenario with respect to each clinical conclusion. According to one embodiment, the following methodology is employed:

Let EE={y:y is an essential element}

Where y ε EE, let max(f(y))=yₘₐₓ, where f(yₘₐₓ) is maximum for all y ε EE

Let μ(y,cc)=membership confidence value of y w.r.t. clinical conclusion cc, where y ε EE

Let ι(y,cc)=criterion impact value of y w.r.t. clinical conclusion cc, where y ε EE

Let α(y,cc)=μ(y,cc)ι(y,cc)

Let BC_{cc}={y ε EE:y=max(μ(y,cc)) and y=max(i(y,CC))

Let P_{T}={z:z ε EE and z is associated with a patient element belonging to temporal segment T}

Let CA={x:x is a category}

Let CL={x:x is a class}

Let Caₙ={z:z ε EE and z belongs to category n}

Let Clₙ={w:w ε CA and w belongs to class n}

μ(Caₙ)=max(μ(z))where zεCaₙ

$$i ( {Ca}_{n} ) = {\sum }_{k = 1}^{N} i ( {z}_{k} , cc ) ( μ ( {z}_{k} , cc ) - 0.5 ) , where {z}_{k} ∈ {Ca}_{n}$$

a(Caₙ)=μ(Caₙ)t(Caₙ)

λ(Caₙ)=αₚ(Caₙ)/α_{b}(Caₙ)

μ(Clₙ)=max(μ(z))where zεClₙ

$$i ( {Cl}_{n} ) = {\sum }_{k = 1}^{N} i ( {z}_{k} ) ( μ ( {z}_{k} ) - 0.5 ) , where {z}_{k} ∈ {Cl}_{n}$$

α(Clₙ)==82 (Clₙ)ι(Clₙ)

λ(Clₙ)=αₚ(Clₙ)/α_{b}(Clₙ)

M=max(μ(z))where z εClₙ

$$I = {\sum }_{k = 1}^{N} i ( {z}_{k} ) ( μ ( {z}_{k} ) - 0.5 ) , where {z}_{k} ∈ CL$$

A=MI

Λ=Aₚ/A_{B}

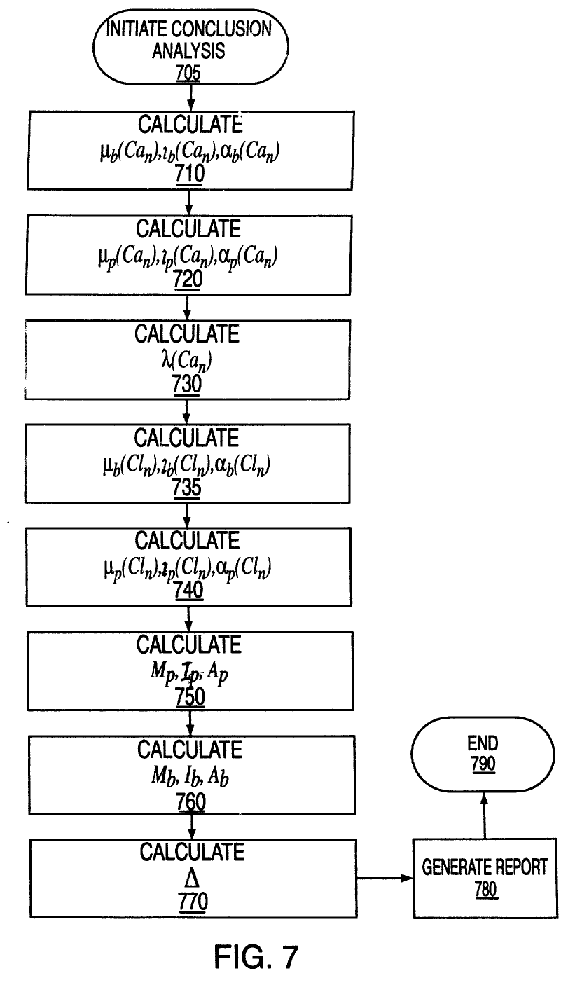

FIG. 7 is a flowchart of steps for generating a clinical conclusion report according to one embodiment of the present invention. It is assumed that it is desired to evaluate a particular temporal segment (e.g., an act) with respect to a particular clinical conclusion. Practitioners skilled in the art will recognize that the following description may be easily extended to evaluate multiple clinical conclusions over multiple temporal segments. The process is initiated in step 705. In step 710, parameters ι_{b}(Caₙ), μ_{b}(Caₙ) and α_{b}(Caₙ) are calculated for each category of BC_{cc}.

In step 720, parameters ιₚ(Caₙ), μₚ(Caₙ) and αₚ(Caₙ) are calculated for each category of P_{T}.

In step 730, λ(Caₙ)=αₚ(Caₙ)/αₚ(Caₙ) is calculated. In step 735, parameters ι_{b}(Clₙ), μ_{b}(Clₙ) and α_{b}(Clₙ) are calculated for each class of BC_{cc}. In step 740, parameters δₚ(Clₙ), μₚ(Clₙ) and αₚ(Clₙ) are calculated for each class of P_{T}. In step 750, parameters Mₚ, Iₚ and Aₚ are calculated. In step 760, parameters M_{b}, I_{b} and A_{b} are calculated. In step 770, Δ=Aₚ/A_{B} is calculated. In step 780, a report is generated. The process ends in step 790.

According to one embodiment, the following pseudo-code, describes a process for a total criteria impact (I), a total membership confidence (M) and an overall level of confidence ratio Λ.

struct confidence_impact
{
float total_criteria_impact_best_case;
float total_membership_confidence_best_case;
float total_criteria_impact_patient;
float total_membership_confidence_patient;
}
confidence_impact* Conclusion_Analysis(eeset * elements, conclusion
conclusion_code)
{
Sort elements into categories;
Calculate μ_{b} (Caₙ), ι_{b} (Caₙ), α_{b} (Caₙ);
Calculate μₚ (Caₙ), ιₚ (Caₙ), αₚ (Caₙ);
Calculate λ(Caₙ);
Calculate μ_{b} (Clₙ), ι_{b} (Clₙ), α_{b} (Clₙ);
Calculate μₚ (Clₙ), ιₚ (Clₙ), αₚ (Clₙ)
Calculate λ(Clₙ);
Calculate M_{b}, I_{b}, A_{b};
Calculate Mₚ, Iₚ, Aₚ;
Calculate Λ;
Return confidence_impact;
}

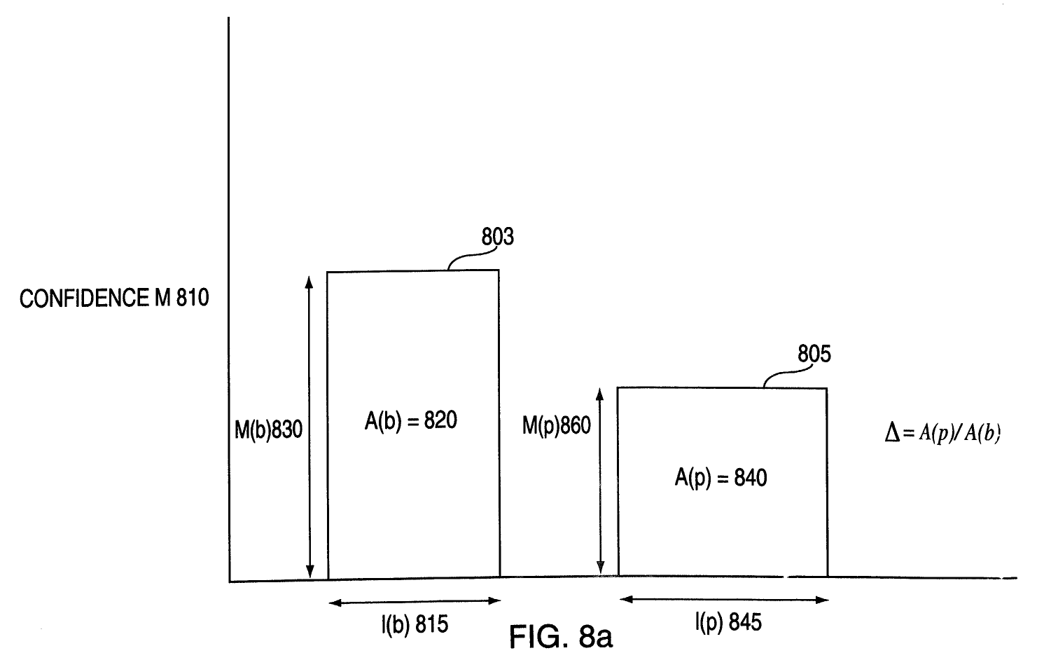

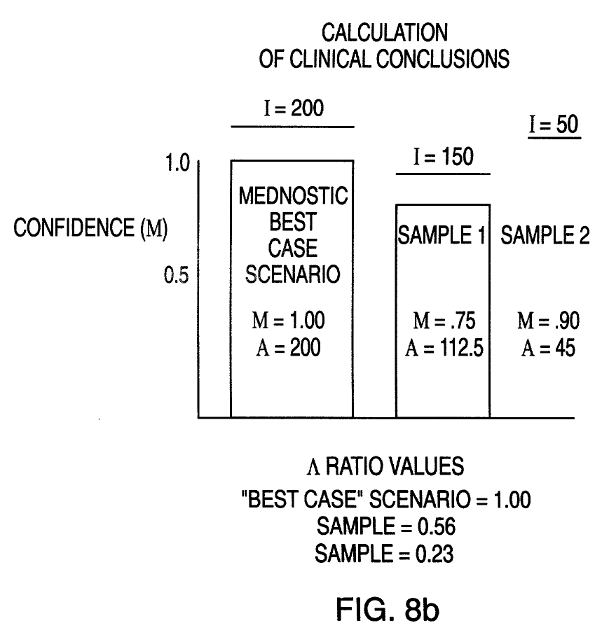

FIG. 8a shows a sample report according to one embodiment of the present invention. FIG. 8 shows patient conclusion analysis result 805 compared with best-case conclusion analysis 803 for a single clinical conclusion with respect to a temporal segment. The area of patient conclusion analysis result 820=M(b) 830 multiplied by I(b) 815. Similarly, the area of best-case conclusion analysis result 840=M(p) 860 multiplied by I(p) 845. Δ represents the ratio between the areas of the actual patient data and the best-case scenario=A(p)/A(b).

FIG. 8b shows an exemplary report including various sample data points according to one embodiment of the present invention.

According to one embodiment of the present invention, value code field 446 of each medical rule record 411 stores a pointer that reference a function that defines μ (confidence parameter) as a function of an independent variable. According to one embodiment, the function may be a fuzzy logic membership function. For example, a particular essential element 107 may be associated with a measurement value such that the confidence parameter μ is determined as a function of the measurement value. Typically, the functional relation maps a certain measurement associated with an essential element 107 to a particular confidence parameter μ for a particular clinical conclusion being considered.

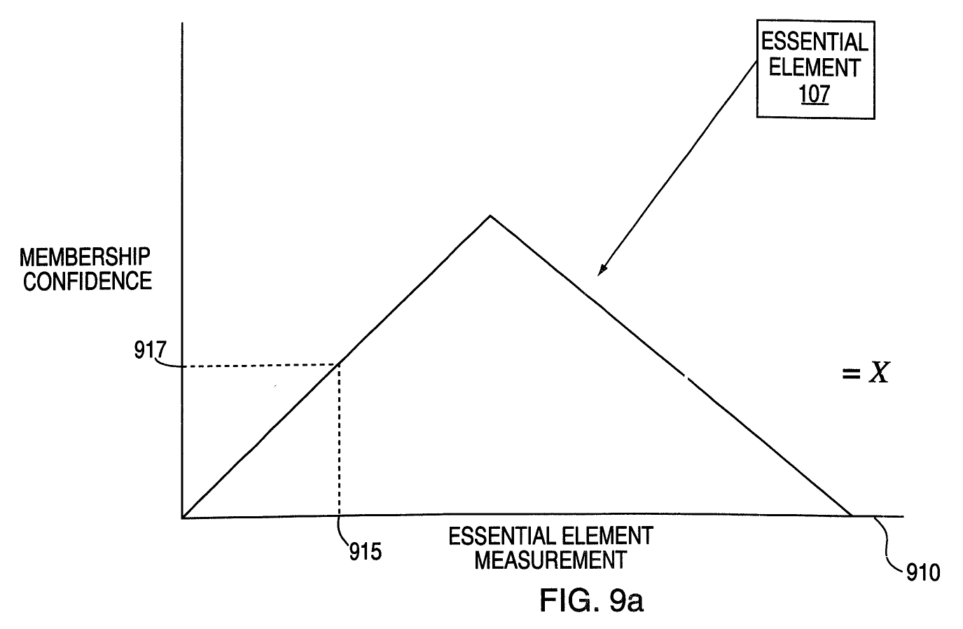

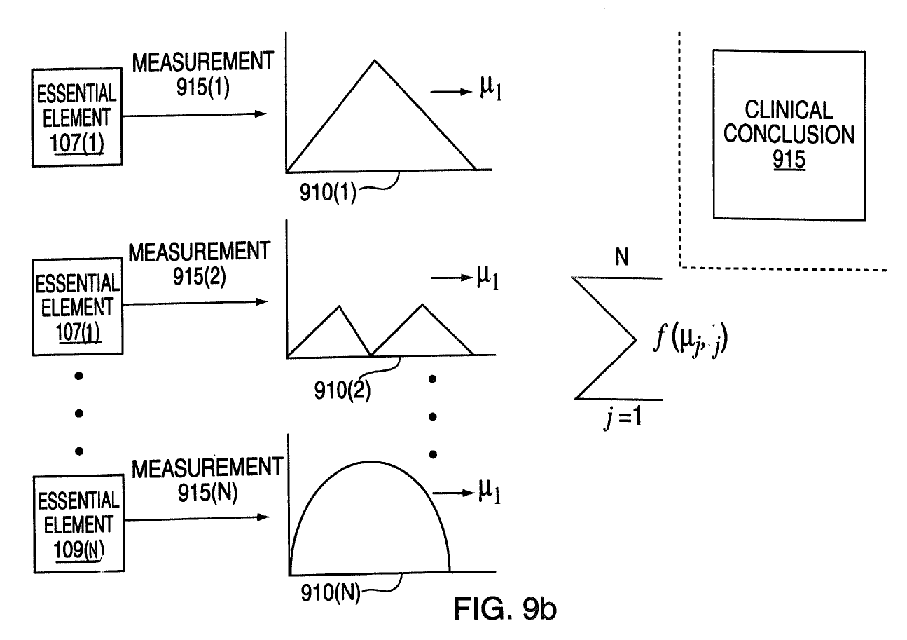

FIG. 9a illustrates an exemplary fuzzy logic membership function relating a measurement value for an essential element with a confidence parameter according to one embodiment of the present invention. As shown in FIG. 9a, for a particular clinical conclusion and essential element 107, fuzzy logic membership function 910 maps a particular measurement value (e.g., 915) to a particular confidence parameter μ (e.g., 917).

FIG. 9b illustrates the evaluation of a clinical conclusion with respect to a number of essential elements according to one embodiment of the present invention. It is assumed that a plurality of essential elements has been determined from raw medical data and corresponding medical rule records have been generated. Further, it is assumed that the determined essential elements 107 are associated with a measurement value 915 such that the confidence parameter μ is determined as a function of the measurement value 915. As shown in FIG. 9b, each relevant essential element 107(1)-107(N) is considered by determining the membership confidence value μ₁-μ_{N} utilizing corresponding function 910(1)-910(N). FIG. 9b illustrates one particular method for determining an overall level of confidence parameter. An overall level of confidence parameter is determined according to the following linear combination of functions f(μⱼ,tⱼ).

$$M = {\sum }_{j = 1}^{N} f ( {μ}_{j} , {t}_{j} ) .$$

Note that functions f(μⱼ,ιⱼ) may be any function such as a simple product weighting. Also, according to alternative embodiments, A may be determined by non-linear methods.

What is claimed is:

1. A method for determining an overall level of confidence for a medical clinical conclusion comprising the steps of:
a. determining at least one medical element from a set of medical data, wherein each medical element is associated with an impact parameter for the medical clinical conclusion;
b. for each medical element, generating a confidence parameter as a function of the medical clinical conclusion; and,
c. determining an overall level of confidence parameter as a function of each of the confidence parameters and the associated impact values.

2. The method according to claim 1, wherein step (a) further includes the step of parsing the set of medical data to match at least one phrase with a previously stored essential element.

3. The method according to claim 1, wherein the confidence parameter is determined as a function of a measurement value.

4. The method according to claim 3, wherein the function is a fuzzy logic membership function.

5. The method according to claim 1, wherein step (c) further includes the step of generating a linear combination of second functions, wherein the second functions take a confidence parameter and impact value as arguments.

6. The method according to claim 5, wherein the second functions generate a product of a confidence parameter and an impact parameter.

7. A system for determining an overall level of confidence for a medical clinical conclusion comprising a processor, wherein the processor is adapted to:
a. determine at least one medical element from a set of medical data, wherein each medical element is associated with an impact parameter for the medical clinical conclusion;
b. for each medical element, generate a confidence parameter as a function of the medical clinical conclusion; and,
c. determine an overall level of confidence parameter as a function of each of the confidence parameters and the associated impact values.

8. A method for determining an overall level of confidence for medical clinical conclusion comprising the steps of:
a. storing a plurality of possible clinical conclusions;
b. storing a plurality of medical essential elements;
c. for each clinical conclusion, storing a plurality of membership functions, wherein each membership function associates an essential element with a clinical conclusion;
d. storing a plurality of impact parameters, wherein each impact parameter associates a weight of an essential element pointing toward a clinical conclusion;
e. determining at least one relevant medical essential element; and,
f. generating an overall confidence parameter for the medical clinical conclusion as a function the at least one relevant medical essential element, the associated membership functions and the impact parameters.

9. A method for determining an overall level of confidence for a medical clinical conclusion comprising the steps of:
a. storing at least one membership function, wherein each membership function relates a medical element with a membership confidence value for a clinical conclusion;
b. storing a criterion impact parameter for each membership function, wherein each criterion impact parameter represents an importance of a medical element with respect to a clinical conclusion; and,
c. determining an overall confidence value for the clinical conclusion, wherein the overall confidence value is determined as a function of at least one membership function and at least one criterion impact parameter.

10. A method for evaluating a medical clinical conclusion comprising the steps of:
(a) storing at least one medical essential element;
(b) storing at least one medical rule, wherein each medical rule associates a medical essential element with a clinical conclusion and at least one of a membership confidence function and an impact parameter;
(c) receiving at least one medical claim item, wherein each medical claim item is associated with a medical essential element and a date parameter;
(d) sequencing the at least one medical claim item as a function of the associated date parameter;
(e) segmenting the at least one medical claim item into at least one chronological segment, wherein each chronological segment includes at least one medical claim item and is associated with a clinical significance; and,
(f) for each chronological segment determining a total membership confidence value with respect to the clinical conclusion based upon the at least one medical rule.

11. A method for evaluating a medical clinical conclusion comprising the steps of:
(a) storing at least one medical essential element;
(b) storing at least one medical rule, wherein each medical rule associates a medical essential element with a clinical conclusion and at least one of a membership confidence function and an importance parameter;
(c) parsing at least one medical record, which includes a plurality of phrases, to generate at least one medical claim item, wherein each medical claim item is associated with a medical essential element and a date parameter;
(d) sequencing the at least one medical claim item as a function of the associated date parameter;
(e) segmenting the at least one medical claim item into at least one chronological segment, wherein each chronological segment includes at least one medical claim item and is associated with a clinical significance; and,
(f) for each chronological segment determining a total membership confidence value with respect to the clinical conclusion as a function of at least one medical rule.

12. The method according to claim 11, wherein step (c) further includes the steps of:
(i) storing at least one phrase element, wherein each phrase element is associated with a medical essential element; and,
(ii) for each of the plurality of phrases in the medical record, locating a matching phrase element.

13. The method according to claim 12, wherein step (e) further includes the steps of:
(i) storing a at least one chronological rule, wherein each chronological rule associates an essential element with a change in a clinical segment; and
(ii) evaluating the medical essential element associated with each medical claim item using a chronological rule to determine at least one segment point.

14. The method according to claim 12, wherein step (f) further includes the steps of:
(i) based upon the at least one medical rule calculating a sum of membership functions multiplied by an impact parameter with respect to the medical clinical conclusion for each medical item; and,
(ii) dividing said sum by a sum of an importance parameter associated with each medical item.

15. A system for evaluating a medical clinical conclusion, comprising:
a database for storing medical essential elements;
a database for storing at least one medical rule, wherein each medical rule associates a medical essential element with a clinical conclusion and at least one of a membership confidence parameter and an importance parameter;
means for receiving at least one medical record, wherein each medical record includes a plurality of phrases;
a processor, wherein the processor is adapted to:
(a) parse the at least one medical record to generate at least one medical claim item, wherein each medical claim item is associated with a medical essential element and a date parameter;
(b) sequence the at least one medical claim item as a function of the associated date parameter;
(c) segment the at least one medical claim item into at least one chronological segment, wherein each chronological segment includes at least one medical claim item and is associated with a clinical significance; and,
(d) calculate a total membership confidence value with respect to a clinical conclusion as a function of at least one medical rule.

16. A method for determining an overall level of confidence for a conclusion comprising the steps of:
a. determining at least one element from a set of data, wherein each element is associated with an impact parameter for the conclusion;
b. for each element, generating a confidence parameter as a function of the conclusion; and,
c. determining an overall level of confidence parameter as a function of each of the confidence parameters and the associated impact values.
